(19) United States
(12) Patent Application Publication
(10) Pub. No.: US 2014/0102226 A1
(43) Pub. Date: Apr. 17, 2014

(54) Sensor device having a positioning device

(71) Applicants: Ronny LUDWIG, Reutlingen (DE); Martin ROJAHN, Tuebingen (DE)

(72) Inventors: Ronny LUDWIG, Reutlingen (DE); Martin ROJAHN, Tuebingen (DE)

(73) Assignee: Robert Bosch GmbH, Stuttgart (DE)

(21) Appl. No.: 14/056,703

(22) Filed: Oct. 17, 2013

(30) Foreign Application Priority Data
Oct. 17, 2012 (DE) 10 2012 218 901.7

(51) Int. Cl. G01D 11/30

(52) U.S. Cl. CPC G01D 11/30
USPC 73/866.5

(57) ABSTRACT

A sensor device, having a screw-shaped fastening element for accommodating a sensor device and for fastening the sensor device, and a positioning device, in which the sensor device is able to be positioned angularly around a longitudinal axis using the positioning device.

### RELATED APPLICATION INFORMATION

The present application claims priority to and the benefit of German patent application no. 10 2012 218 929.7, which was filed in Germany on Oct. 17, 2012, the disclosure of which is incorporated herein by reference.

### FIELD OF THE INVENTION

The present invention relates to a sensor device. The present invention furthermore relates to a device for unlatching a sensor device. The present invention also relates to a method for electrically contacting a screw-shaped sensor device.

### BACKGROUND INFORMATION

Sensors for detecting physical variables such as e.g. rotational speed, acceleration, pressure etc. are installed in plastic housings, which are mounted in a motor vehicle using screws and are electrically contacted by a plug. For example, in a so-called peripheral acceleration sensor of the sixth generation (“PAS6”), an electrical sensor unit is formed, which includes a MEMS acceleration chip, an ASIC as well as passive components, which all are combined in an LGA (land grid array) enveloped or molded using an injection molding process. The LGA is fixed in place by electrically conductive insertion parts (ELT), which at the same time act as electrical control contacts toward the outside. The LGA fixed in place and electrically contacted by the insertion parts is extrusion coated by a thermosetting plastic material. Subsequently, this unit (a so-called “lolly”) is extrusion coated by a thermosetting plastic material, which acts as a housing having sockets and as a plug unit of the sensor.

German patent document DE 10 2009 027 995 A1 discusses a device having a semiconductor component and a housing, the housing having at least one electrical terminal and at least one fastening point. The housing has a first encasing made of thermosetting plastic, which essentially envelops the semiconductor component.

### SUMMARY OF THE INVENTION

According to a first aspect, the present invention creates a sensor device, having:
a screw-shaped fastening element for accommodating a sensor device and for fastening the sensor device; and
a positioning device,
   wherein the sensor device is able to be positioned angularly around a longitudinal axis using the positioning device.

According to a second aspect, the present invention provides a device for unlatching a sensor device, having an essentially fork-shaped construction, which is insertable into hollow regions of a screw head of the sensor device, latching elements of the sensor device being thereby unlatchable, the device being stepped or beveled in end sections.

According to a third aspect, the present invention creates a method for electrically contacting a screw-shaped sensor device, which has the following steps:
screwing the sensor device into an object to be sensed until latching elements latch into recesses on the object to be sensed; and
inserting a plug into contacting elements of the latched sensor device.

Further developments of the present invention are the subject matter of dependent claims.

One specific embodiment of the sensor device is characterized in that the positioning device has at least two latching elements, one latching element respectively being situated in one springy region of a screw head of the sensor device. The sensor device is thereby advantageously electrically contacted only after having reached a specified installation position with the aid of the positioning device. A user is thus able to plug a counterplug on the sensor device only if the sensor device previously latched in latching position.

One specific embodiment of the sensor device according to the present invention is characterized by the fact that the latching elements are pin-shaped. This advantageously supports a good fit of the sensor device on an object to be sensed.

One specific embodiment of the sensor device according to the present invention is characterized by the fact that the pin-shaped latching elements have different diameters. This advantageously supports a latching following respectively complete rotations of the sensor device about a longitudinal axis and prevents an undesired, premature latching of the sensor device following respectively half rotations.

One specific embodiment of the sensor device is characterized by the fact that the latching elements are developed as metallic insertion parts. This advantageously makes it possible to apply very high forces onto the sensor device for securing it, which supports a secure fit of the sensor device on the object to be sensed.

One specific embodiment of the sensor device according to the present invention is characterized by the fact that the metallic insertion parts are springy in hollow regions of the screw head of the sensor device. This advantageously supports a simple unlatching of the latching elements using a suitable tool.

One specific embodiment of the sensor device according to the present invention is characterized by the fact that the latching elements are developed so as to be capable of being unlatched. This makes it possible for the latching elements to be for example prised out in a simple manner for removing the sensor device, whereby the sensor device is able to be released from the object to be sensed.

One specific embodiment of the sensor device according to the present invention is characterized by the fact that two of the latching elements are offset by about 180 degrees with respect to each other. This advantageously makes it possible to latch the latching elements following respectively complete rotations of the sensor device about a longitudinal axis, which supports the attainment of a required torque when latching and ensures a high vibration resistance for the sensor device. This simplifies a monitoring of the torque during a locking process.

A specific embodiment of the sensor device according to the present invention is characterized by the fact that at least two radially offset prestressing elements are provided, by which an axial force may be applied between an object to be sensed and the screw head. The mentioned prestressing elements make it possible advantageously to apply a prestress force, the prestressing elements acting as a kind of spring ring.

One specific embodiment of the sensor device according to the present invention is characterized by the fact that the latching elements and the prestressing elements are developed as a combination element. This makes it possible to save insertion parts.

One specific embodiment of the sensor device according to the present invention is characterized by the fact that the latching elements have a greater radial distance from the longitudinal axis of the sensor device than the prestressing elements. In this manner, it is possible to achieve a particularly precise angular positioning of the sensor device together with favorable prestress forces.

It is regarded to be particularly advantageous in the present invention that the positioning device makes it possible to lock the sensor device in an angularly precisely defined position. This advantageously makes it possible to position sensor devices that have high requirements in terms of a three-dimensional orientation with great precision, which advantageously ensures very precise sensing characteristics of the mentioned sensor devices. This makes it possible for the sensor device to achieve sensing characteristics that are precise not only in a longitudinal axis of the sensor, but in all spatial coordinates. The sensor device according to the present invention thus advantageously solves a positional accuracy problem for sensors that are sensitive in terms of position.

Additional features and advantages of the present invention are explained below on the basis of specific embodiments and with reference to the figures. In this context, all of the described or represented features, alone or in any combination, form the subject matter of the present invention, regardless of their combination in the patent claims or their antecedent reference, and regardless of their wording and representation in the specification and in the figures. The figures are primarily intended to clarify the principles that are essential to the present invention and are not necessarily to be understood as diagrams true to detail and true to scale.

In the figures, identical reference symbols denote identical or functionally equivalent elements.

### BRIEF DESCRIPTION OF THE FIGURES

FIG. 1 shows a representation in principle of a first specific embodiment of the sensor device according to the present invention.

FIG. 2 shows another specific embodiment of the sensor device according to the present invention.

FIG. 3 shows another specific embodiment of the sensor device according to the present invention.

FIG. 4 shows another specific embodiment of the sensor device according to the present invention.

FIG. 5 shows another specific embodiment of the sensor device according to the present invention.

FIG. 6 shows a device for unlatching the sensor device according to the present invention.

FIG. 7 shows a representation in principle of a fastening device for the exact fastening of the sensor device.

FIG. 8 shows a front view of the fastening device shown in FIG. 7.

### DETAILED DESCRIPTION

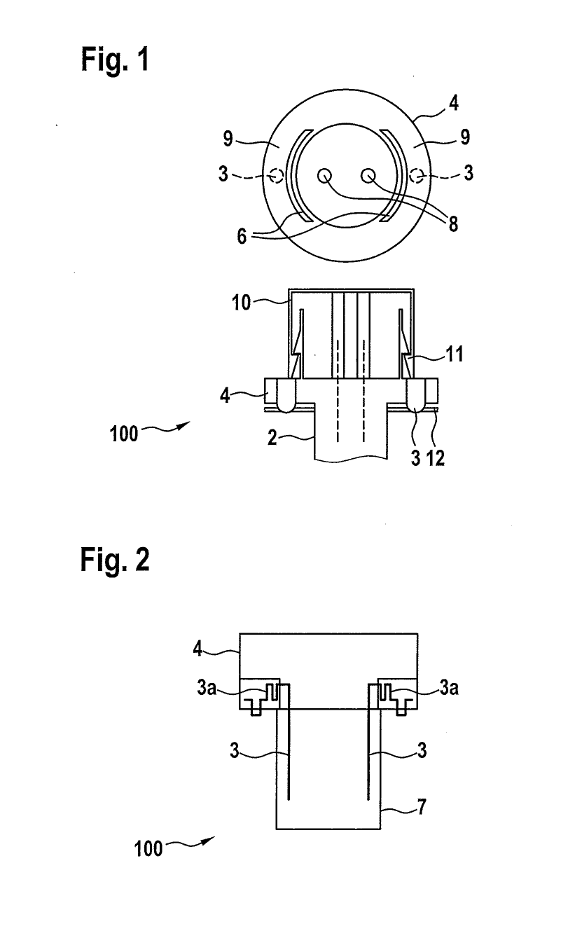

In an upper representation, FIG. 1 shows a basic top view and in a lower representation a basic front view of one specific embodiment of the sensor device 100 according to the present invention. Sensor device 100 includes a screw-shaped fastening element 2, in which a sensor component 1 (not shown) is accommodated and fixed in place. Screw-shaped sensor device 100 includes a screw head 4, which forms springy regions 9 on screw head 4 by two gaps 6. This allows for deflections of the mentioned springy regions 9 essentially in parallel to a longitudinal axis of sensor device 100. A pin-shaped, rounded latching element 3 is disposed in each of springy regions 9, which latches into recesses (for example holes or indentations in an automotive body sheet metal 12).

Contacting elements 8 of sensor component 1 are developed as metallic insertion parts and protrude from sensor device 100.

The lower representation of FIG. 1 providing the front view of sensor device 100 shows that a plug 10 may only be plugged onto sensor device 100 once latching elements 3 have latched on both sides of screw head 4 into recesses of automotive body sheet metal 12, which ensures that sensor device 100 is positioned with angular precision. When plugging electric plug 10 into a socket of sensor device 100, an edge of plug 10 extends up to screw head 4. Only in this case is it possible for latches 11 of plug 10 to latch into latches of sensor device 100 and consequently for plug 10 to be plugged completely into the socket. This advantageously allows for an efficient and error-free electrical contacting of sensor component 1 of sensor device 100.

In angle-sensitive applications (such as e.g. sensors for rotational speed, acceleration etc.), the described measures support a high angular accuracy in the positioning of sensor device 100 when mounting it in automotive body sheet metal 12.

Independently of the latching mechanism, a thread shape (rise, etc.) of screw-shaped sensor device 100 ensures that prior to latching a specified screwing torque is reached.

Alternatively, latching elements 3 may also be metallic insertion parts, which are fixed in place in the (plastic) hollow screw body of sensor device 100, developed as springy lugs, which latch into indentations of automotive body sheet metal 12 provided for this purpose. FIG. 2 shows such a variant of the sensor device 100 according to the present invention. One can see that latching element 3 is developed a a metallic insertion part for the angular locking of sensor device 100. The metallic insertion part is anchored in a screw body 7 and extends in a hollow region of screw head 4, the insertion part forming a springy region 3a in the hollow region.

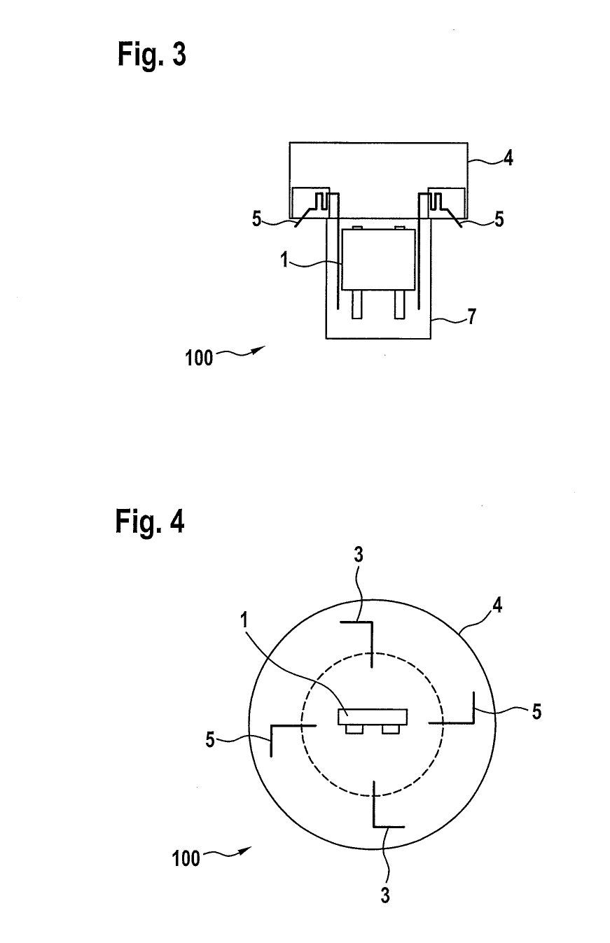

FIG. 3 shows a detail of another specific embodiment of the sensor device 100 according to the present invention. It can be seen that now also a prestressing element 5 developed as a metallic insertion part extends into hollow regions of screw head 4. Prestressing element 5 is used to apply a prestress force between screw head 4 and a surface of the object to be sensed (e.g. automotive body sheet metal 12). Prestressing element 5 thus takes on functionally the task of a mechanical spring ring. FIG. 3 also shows a representation in principle of a sensor component 1, which may be developed as an LGA (land grid array) held by insertion parts.

FIG. 4 shows a top view of another specific embodiment of sensor device 100 according to the present invention. It can be seen that latching elements 3 and prestressing elements 5 are offset with respect to each other essentially by 180 degrees. This configuration advantageously makes it possible to position sensor device 100 angularly in an exact manner using latching elements 3 and additionally to build up a favorable prestress force between sensor device 100 using prestressing elements 5.

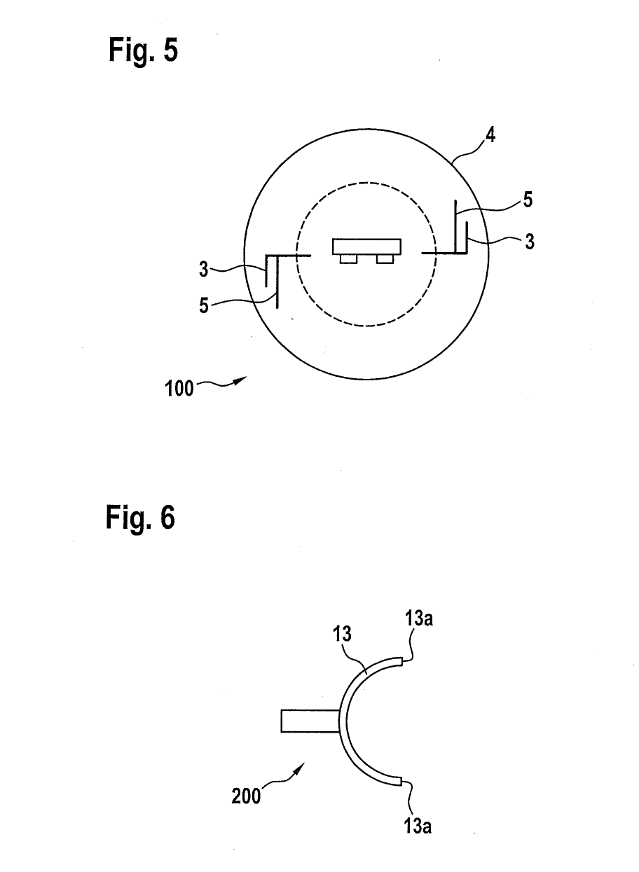

FIG. 5 shows a top view of another variant of sensor device 100 according to the present invention. One can see that in this case now latching elements 3 and prestressing elements 5 together form a combination element. Advantageously, this makes it possible to save a number of metallic insertion parts.

FIG. 6 shows a device 200 for unlatching latching elements 3 for the purpose of releasing sensor device 100. Device 200 is developed as a tool 13, which has beveled or stepped regions in edge sections 13a. When needed, tool 13 is inserted laterally into screw head 4 of sensor device 100, as a consequence of which springy regions 3a of latching elements 3 may be pushed upward. In this manner, tool 13 allows for a simple unlocking or unlatching and thus an exchange of sensor device 100.

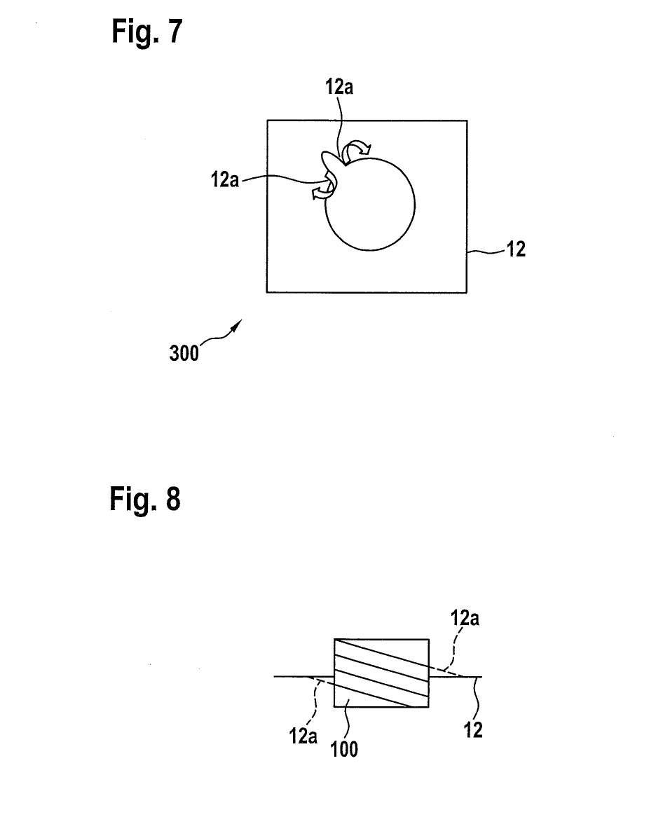

FIG. 7 shows a specific embodiment of a fastening device 300 for sensor device 100 of the present invention in an automotive body sheet metal 12. For this purpose, automotive body sheet metal 12, the thickness of which corresponds approximately to an order of magnitude of one screw rotation, has preimpressions 12a, which are developed for the purpose of screwing in sensor device 100 perpendicularly. Said preimpressions 12a, which are bent in opposite directions (see arrows) make it possible to screw sensor device 100, as shown in FIG. 8, essentially perpendicularly into automotive body sheet metal 12. In the case of a thick automotive body sheet metal 12 having a prestamped thread or in the case of a nut (not shown) affixed on automotive body sheet metal 12, preimpressions 12a may be omitted.

In this manner, it is advantageously possible to omit additional screw-on components in the vehicle, as a result of which sensor device 100 may be screwed into an automotive body sheet metal 12 prepared by stamping and impression, thus using available space in auto body cavities.

Users advantageously require no separate screw and no thread fastened to the auto body in order to fasten sensor device 100 perpendicularly, but only require a thread turn in automotive body sheet metal 12 produced by stamping and impression, which results in a significant cost reduction.

In summary, the present invention provides a sensor device that allows for a locking mechanism that has a very precise fit and angular accuracy. For sensors having high precision requirements with respect to a geometric orientation of the sensor (e.g. in ESP systems, in which a rate of rotation about a vertical z axis and not about the x or y axis of the vehicle is to be measured), this advantageously supports the exact sensing in multiple different coordinate axes.

Due to the fact that the desired sensing axes cannot always be oriented along the longitudinal axis of the screw (e.g. when different sensors are integrated in the screw), an achievable angular accuracy of the sensor device of the present invention directly affects a specification and application suitability of the sensor device.

Although the present invention was described with reference to the exemplary embodiments, it is not limited to these. One skilled in the art will therefore be able to modify or combine with one another the described features of the present invention without deviating from the essence of the present invention.

What is claimed is:

1. A sensor device, comprising:
a sensor arrangement, including:
a screw-shaped fastening element for accommodating a sensor component and for fastening the sensor arrangement; and
a positioning device;
wherein the sensor arrangement is positionable angularly around a longitudinal axis using the positioning device.

2. The sensor device of claim 1, wherein the positioning device has at least two latching elements, in which one latching element is situated in respectively one springy region of a screw head of the sensor arrangement.

3. The sensor device of claim 2, wherein the latching elements are pin-shaped.

4. The sensor device of claim 3, wherein the pin-shaped latching elements have different diameters.

5. The sensor device of claim 1, wherein the latching elements are configured as metallic insertion parts.

6. The sensor device of claim 6, wherein the metallic insertion parts are springy in hollow regions of the screw head of the sensor arrangement.

7. The sensor device of claim 2, wherein the latching elements are unlatchable.

8. The sensor device of claim 1, wherein two of the latching elements are offset by approximately 180 degrees with respect to each other.

9. The sensor device of claim 1, further comprising:
at least two radially offset prestressing elements, by which an axial force may be applied between an object to be sensed and the screw head.

10. The sensor device of claim 9, wherein the latching elements and the prestressing elements are configured as a combination element.

11. The sensor device of claim 9, wherein the latching elements have a greater radial distance from the longitudinal axis of the sensor device than the prestressing elements.

12. A fastening device for a sensor device, comprising:
a fastening arrangement having a through-opening in a planar metal having a gap, adjacent regions of the gap being bent in opposite directions, a resulting rise relative to the planar metal essentially corresponding to a rise of a thread turn of the sensor device;
wherein the sensor device includes a sensor arrangement, having a screw-shaped fastening element for accommodating a sensor component and for fastening the sensor arrangement, and a positioning device, in which the sensor arrangement is positionable angularly around a longitudinal axis using the positioning device.

13. A device for unlatching a sensor device, comprising:
an unlatching arrangement having an essentially fork-shaped construction, which is insertable into hollow regions of a screw head of the sensor device, wherein latching elements of the sensor device are unlatchable, the sensor device being stepped or beveled in end sections;
wherein the sensor device includes a sensor arrangement, having a screw-shaped fastening element for accommodating a sensor component and for fastening the sensor arrangement, and a positioning device, in which the sensor arrangement is positionable angularly around a longitudinal axis using the positioning device.

14. A method for electrically contacting a screw-shaped sensor device, the method comprising:
screwing the sensor device into an object to be sensed until latching elements latch into recesses on the object to be sensed; and
inserting a plug into contacting elements of the latched sensor device.
